(19) United States
(12) Patent Application Publication
(10) Pub. No.: US 2026/0326770 A1
(43) Pub. Date: Oct. 22, 2026

(54) METHOD AND VEHICLE FOR ESTIMATING STATE OF TRACKED OBJECT

(71) Applicants: Hyundai Motor Company, Seoul (KR); Kia Corporation, Seoul (KR)

(72) Inventor: Ji Yang MOON, Hwaseong-Si (KR)

(73) Assignees: Hyundai Motor Company, Seoul (KR); Kia Corporation, Seoul (KR)

(21) Appl. No.: 19/401,073

(22) Filed: Nov. 25, 2025

(30) Foreign Application Priority Data
Apr. 16, 2025 (KR) 10-2025-0049387

(51) Int. Cl. B60W 50/00; B60W 40/04

(52) U.S. Cl. CPC B60W 50/0097; B60W 40/04; B60W 2050/0021; B60W 2554/4042; B60W 2554/4044

(57) ABSTRACT

A method for estimating state of tracked object, includes: generating ego behavior influence data of a host vehicle based on a predicted speed of the tracked object at a first time point, the predicted speed of the tracked object being provided from sensor data, and an estimated speed of the tracked object perceived at a second time point preceding the first time point; generating absolute heading data of the tracked object at the first time point based on the ego behavior influence data and an estimated speed of the tracked object perceived at the first time point; and generating an absolute heading change rate of the tracked object based on the absolute heading data and heading data of the tracked object at the second time point.

### CROSS-REFERENCE TO RELATED APPLICATION

The present application claims priority to Korean Patent Application No. 10-2025-0049387, filed on Apr. 16, 2025, the present disclosure of which is incorporated herein by reference in its entirety.

### FIELD OF TECHNOLOGY

The present disclosure relates to a method and vehicle for estimating a state of a tracked object, and more specifically, to a method and vehicle for estimating a state of a tracked object that improves the accuracy of object tracking.

### BACKGROUND

In recent years, vehicles have been commercially available with various functions to enhance the convenience of drivers. In particular, a technology has been developed in which an autonomous driving function is applied to a vehicle, and the vehicle may control driving by itself with minimal or no intervention by a driver.

This autonomous driving function is designed so that the vehicle may recognize the surrounding environment through various types of heterogeneous sensors, and accurately identify the situation around the vehicle based on this. Here, the area or data in which the object detected by the sensor is recognized is a track, and the vehicle establishes a control plan for autonomous driving according to the identified situation to control the actuator, thereby realizing safe and efficient driving.

In the present process, the heading change rate of the track may be state data of the track used to predict the path of the track or to estimate the startup of the vehicle. The tracking system may define a heading of the track in the coordinate system of the host vehicle center. The behavior of the track-related object as well as the behavior of the host vehicle may influence the calculation of the heading change rate. In a case where the host vehicle makes a turning driving, it may be misunderstood that a track that is actually stopped has a heading change. This misperception phenomenon may result in performance degradation of the tracking system, and may act as a major factor that impairs reliability and accuracy of the autonomous driving technology.

### BRIEF SUMMARY

Various aspects of the present disclosure is to provide a method and vehicle of estimating a state of a tracked object that improves the accuracy of object tracking.

The various aspects to be achieved in an exemplary embodiment of the present disclosure are not limited to the above-mentioned technical problems, and other technical problems not mentioned will be clearly understood by a person skilled in the art from the following description.

According to various aspects of the present disclosure, there is provided a method for estimating a state of a tracked object, including: generating ego behavior influence data of a host vehicle based on a predicted speed of the tracked object at a first time point, the predicted speed of the tracked object being provided from sensor data, and an estimated speed of the tracked object perceived at a second time point preceding the first time point; generating absolute heading data of the tracked object at the first time point based on the ego behavior influence data and an estimated speed of the tracked object perceived at the first time point; generating an absolute heading change rate of the tracked object based on the absolute heading data and heading data of the tracked object at the second time point; and controlling the host vehicle based on the absolute heading change rate of the tracked object.

According to various aspects of the present disclosure, the predicted speed of the tracked object at the first time point may be predicted based on data of a track associated with the tracked object perceived at the second time point, and the estimated speed of the tracked object at the second time point may be generated based on a speed of the tracked object included in state data of the track corresponding to the second time point.

According to various aspects of the present disclosure, the estimated speed of the tracked object at the first time point may be generated based on data of a track associated with the tracked object perceived at the first time point.

According to various aspects of the present disclosure, the absolute heading data may include a heading angle of the tracked object in an absolute coordinate system employed based on a predetermined point, and the absolute heading data may be generated to convert the heading angle of the tracked object from a coordinate system of the host vehicle center to the absolute coordinate system.

According to various aspects of the present disclosure, the ego behavior influence data and the estimated speed of the tracked object at the first time point may be described as two-dimensional vector data, and the absolute heading data may be generated by an inverse trigonometric function for a difference between the estimated speed of the tracked object at the first time point and the ego behavior influence data.

According to various aspects of the present disclosure, the heading data of the tracked object at the second time point may be generated based on data of a track associated with the tracked object perceived at the second time point, and may include a heading angle of the tracked object in an absolute coordinate system employed based on a predetermined point,

According to various aspects of the present disclosure, the controlling of the host vehicle may include generating, based on the absolute heading change rate and data of a track associated with the tracked object, the track information that estimates a state of the tracked object; and controlling, based on the track information, an operation of the host vehicle.

According to various aspects of the present disclosure, the controlling of the operation of the host vehicle may include controlling driving of the host vehicle based on the track information.

According to various aspects of the present disclosure, the method may further comprise, before the generation of the absolute heading data, associating the tracked object based on a similarity between the tracked object perceived at the first time point and the tracked object at the second time point; and generating an estimated speed of the tracked object at the first time point based on data of the associated tracked object.

According to various aspects of the present disclosure, there is provided a vehicle, including: a sensor unit detecting a surrounding environment of the vehicle; a memory storing at least one instruction; and at least one processor communicatively to the sensor unit and the memory and executing the at least one instruction stored in the memory. The at least one processor is configured to: generate ego behavior influence data based on a predicted speed of the tracked object at a first time point, the predicted speed of the tracked object being provided from sensor data obtained by the sensor unit, and an estimated speed of the tracked object perceived at a second time point preceding the first time point; generate absolute heading data of the tracked object at the first time point based on the ego behavior influence data and an estimated speed of the tracked object at the first time point; generate an absolute heading change rate of the tracked object based on the absolute heading data and heading data of the tracked object at the second time point; and control the vehicle based on the absolute heading change rate of the tracked object.

The features briefly summarized above for the present disclosure are only exemplary aspects of the detailed description of the present disclosure which follow, and are not intended to limit the scope of the present disclosure.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a diagram illustrating that a vehicle communicates with another device to transmit and receive data.

FIG. 2 is a diagram illustrating modules that configures a vehicle according to an exemplary embodiment of the present disclosure.

FIG. 3 is a diagram schematically illustrating object recognition using sensor data.

FIG. 4 is a diagram illustrating modules that configures a server according to an exemplary embodiment of the present disclosure.

FIG. 5 is a flowchart of a method for estimating a state of a tracked object according to another exemplary embodiment of the present disclosure.

FIG. 6 is a diagram illustrating a tracked object and a track in a relative coordinate system of a vehicle center.

FIG. 7A is a diagram illustrating an example of a behavior change of a host vehicle.

FIG. 7B is a diagram illustrating a yaw rate of a tracked object in each of an absolute coordinate system and a relative coordinate system of a vehicle center in an example of a behavior change of a host vehicle.

FIG. 8A is a diagram illustrating another example of a behavior change of a host vehicle.

FIG. 8B is a diagram illustrating a yaw rate of a tracked object in each of an absolute coordinate system and a relative coordinate system of a vehicle center in another example of a behavior change of a host vehicle.

### DETAILED DESCRIPTION

Hereinafter, various exemplary embodiments of the present disclosure will be described in detail with reference to the accompanying drawings so that those skilled in the art may easily implement the present disclosure. However, the present disclosure may be implemented in various different ways, and is not limited to the exemplary embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In an exemplary embodiment of the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. Furthermore, when an element “includes” or “has” another element, this means that one element may further include another element without excluding another component unless specifically stated otherwise.

In an exemplary embodiment of the present disclosure, the terms first, second, etc. are only used to distinguish one element from another and do not limit the order or the degree of importance between the elements unless specifically mentioned. Accordingly, a first element in an exemplary embodiment could be termed a second element in another exemplary embodiment of the present disclosure, and similarly, a second element in an exemplary embodiment could be termed a first element in another exemplary embodiment of the present disclosure, without departing from the scope of the present disclosure.

In an exemplary embodiment of the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In an exemplary embodiment of the present disclosure, elements described In various embodiments do not necessarily mean essential elements, and some thereof may be optional elements. Therefore, an exemplary embodiment composed of a subset of elements described in an exemplary embodiment of the present disclosure is also included in the scope of the present disclosure. Furthermore, various exemplary embodiments including other elements in addition to the elements described in the various exemplary embodiments of the present disclosure are also included in the scope of the present disclosure.

The advantages and features of the present disclosure and the way of attaining them will become apparent with reference to various exemplary embodiments described below in detail in conjunction with the accompanying drawings. Embodiments, however, may be embodied in many different forms and should not be constructed as being limited to example embodiments set forth herein. Rather, these embodiments are provided so that the present disclosure will be complete and will fully convey the scope of the present disclosure to those skilled in the art.

In an exemplary embodiment of the present disclosure, each of phrases such as “A or B”, “at least one of A and B”, “at least one of A or B”, “A, B or C”, “at least one of A, B and C”, “ ” at Each of the phrases such as “at least one of A, B or C” and “at least one of A, B, C or combination thereof” may include any one or all possible combinations of the items listed together in the corresponding one of the phrases.

In an exemplary embodiment of the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, various exemplary embodiments of the present disclosure will be described with reference to the accompanying drawings.

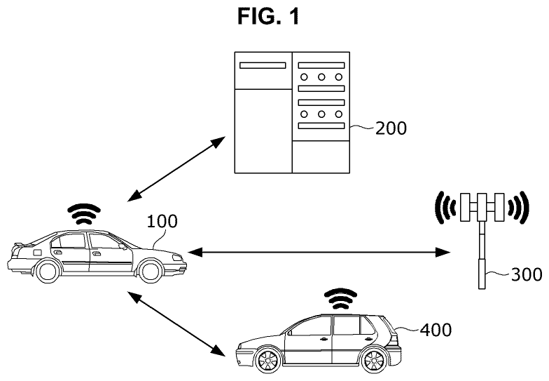

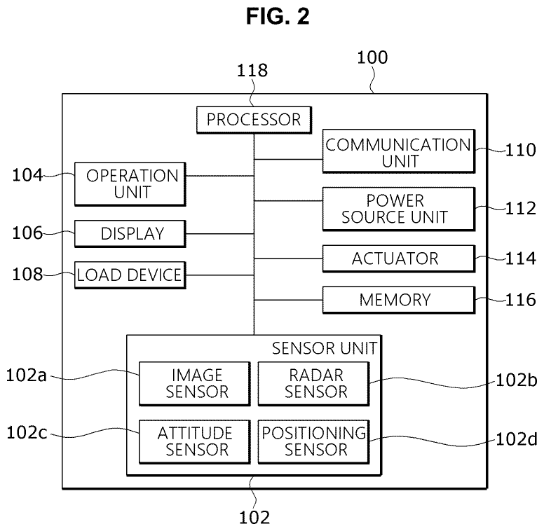

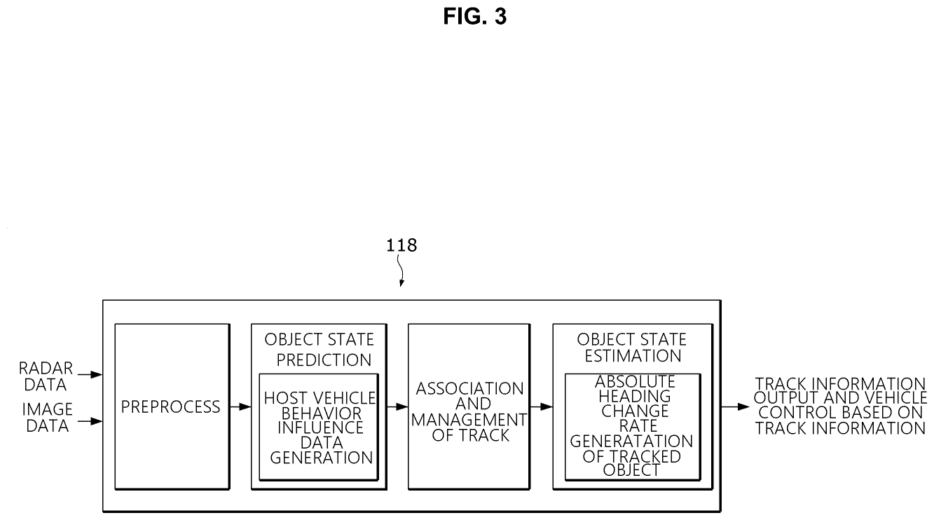

Hereinafter, a vehicle that processes a track of an object recognized from sensor data will be described with reference to FIG. 1, FIG. 2, and FIG. 3.

FIG. 1 is a diagram illustrating that a vehicle communicates with another device to transmit and receive data.

Referring to FIG. 1, a vehicle 100 may be driven on an electrical energy or fossil energy basis. In the case of electrical energy, the vehicle 100 may include, for example, a pure battery-based vehicle driven only by a high-voltage battery or a gas-based fuel cell as an energy source. Furthermore, the fuel cell may utilize various forms of gas configured for generating electrical energy, and the gas may be filled into the vehicle 100, for example, in a liquefied state. Here, the gas may be, for example, hydrogen. However, various gases are applicable without being limited thereto. In the case of fossil energy, the vehicle 100 may be driven based on a fuel, such as gasoline, diesel, or liquefied gas, and may be disposed with an internal combustion engine that drives an actuator 114 by combustion of the fuel. The engine may be included in a power source unit 112 in terms of providing a driving rotation force of a wheel. As an exemplary embodiment of the present disclosure, the vehicle 100 may selectively utilize the energy of a fossil energy-based internal combustion engine and an electric battery to drive the actuator 114, which may be a hybrid type of vehicle.

The vehicle 100 may refer to a device configured for moving. The vehicle 100 is a ground vehicle driving on the ground, and may be a conventional passenger or commercial vehicle, a Purpose Built Vehicle (PBV), or the like. The vehicle 100 may be a four-wheeled vehicle, such as a passenger car, an SUV, a small truck, or may be a vehicle with more than four wheels, such as a bus, a large truck, a container transport vehicle, a heavy-equipment vehicle, or the like. The vehicle 100 may be a robot in a broad sense, such as a moving means, and the robot may be moved using wheels, tracks, or other moving modules.

The vehicle 100 may be controlled and driven by manual driving or autonomous driving due to the driving of a user. The autonomous driving may be implemented as semi-autonomous driving or fully autonomous driving. The fully autonomous driving may be disposed with autonomous movement in which a processor 118 of the vehicle 100 fully controls control without user intervention, even if the driving situation is uncertain. The semi-autonomous driving may be provided in an autonomous movement in which driver intervention is required according to a specific driving situation. The semi-autonomous driving may be implemented so that the processor 118 switches control to the user while deactivating autonomous driving upon the occurrence of the situation, thereby causing the user to perform manual driving. According to the level of autonomous driving defined in the American Society of Automotive Engineers SAE, the semi-autonomous driving corresponds to autonomous driving levels 1 to 4, and the fully autonomous driving may correspond to level 5.

On the other hand, the vehicle 100 may communicate with other devices 200, 300 or another vehicle 400. Other devices may include, for example, a server 200 that supports various controls, state management, and driving of the vehicle 100, an ITS device 300 that receives information from an intelligent transportation system (ITS), various types of user devices, and the like. The server 200 is, for example, an external device operated by a vehicle manufacturer or provided to service a driving support function, and may receive connected data of the vehicle 100 or transmit data necessary for manual and autonomous driving. The server 200 may transmit various information and software modules used for control of the vehicle 100 to the vehicle 100 in response to requests and data transmitted from the vehicle 100 and a user device, to support driving of the vehicle 100 and various services.

The ITS device 300 is, for example, a roadside base station (RSU), and the ITS device 300 may interchange vehicle recognition data, driving control and state data, environment data around the vehicle, map data, and the like through Vehicle-To-Infrastructure (V2I) with the vehicle 100 to assist the user's driving of the vehicle or support autonomous driving of the vehicle 100. The vehicle 100 may support manual driving or autonomous driving by interchanging the above-listed data through Vehicle-To-Vehicle (V2V) with the other vehicle 400.

The vehicle 100 may communicate with other vehicles or other devices based on cellular communication, Wireless Access in Vehicular Environment (WAVE) communication, Dedicated Short Range Communication (DSRC) or Near Field Communication, or other communication schemes.

For example, the vehicle 100 may use a communication network such as LTE or 5G, a WiFi communication network, a WAVE communication network, or the like as a cellular communication network for communication with the server 200, the ITS device 300, or the other vehicle 400. As an exemplary embodiment of the present disclosure, a DSRC or the like used in the vehicle 100 may be used for communication between vehicles. A communication manner between the vehicle 100, the server 200, the ITS device 300, another vehicle 400, and a user device is not limited to the foregoing embodiment.

FIG. 2 is a diagram illustrating modules that configures a vehicle according to an exemplary embodiment of the present disclosure.

The vehicle 100 may include a sensor unit 102, an operation unit 104, a display 106, a load device 108, and a communication unit 110.

The sensor unit 102 may include various types of sensors for detecting various states and situations occurring in an external surrounding environment, an internal system, a user operation, and a boarding space of the vehicle 100.

The sensor unit 102 may include an externally-oriented image sensor 102a, a radio detection and ranging (RADAR) sensor 102b, and the like to recognize dynamic and static objects existing in the periphery of the vehicle 100.

The image sensor 102a may recognize an external object as an image during use of the vehicle 100, generate image data, and transmit the image data to the processor 118. The at least one image sensor 102a may be disposed at a specific site of the vehicle 100, such as a front site, a rear site, a lateral site of the vehicle 100. When a plurality of image sensors 102a are disposed on each site, it may be referred to as a multi-camera in an exemplary embodiment of the present disclosure. The image data obtained by the plurality of image sensors 102a may be referred to as multi-view image data. Although not shown, the sensor unit 102 may further include a camera directed toward the interior of the vehicle 100.

The radar sensor 102b may emit radio waves of a specific frequency around the vehicle 100 to generate radar data through the radio waves reflected from an external object to understand the presence and relative distance, velocity, direction, etc. of the external object. In an exemplary embodiment of the present disclosure, the radar sensor 102b recognizes an object in a manner different from that of the image sensor 102a, and thus may be a type of heterogeneous sensor different from the image sensor 102a.

In an exemplary embodiment of the present disclosure, it is illustrated that a LiDAR sensor is not disposed, but in an exemplary embodiment of the present disclosure, the LiDAR sensor may be disposed on the vehicle 100. The LiDAR sensor may be configured to generate and transmit point cloud data as recognized data of the external object to the processor to generate three-dimensional spatial information identifying at least a shape of an external object. The LiDAR sensor may be a type of heterogeneous sensor different from the image sensor 102a.

The sensor unit 102 may include an attitude sensor 102c. The attitude sensor 102c may detect, for example, three-axis states of the vehicle 100, such as yaw, pitch, and roll, and output various pose states of the vehicle based on the factors described above. The attitude sensor may be configured, for example, as an IMU (Inertial Measurement Unit) sensor, a gyro sensor, or the like. The processor 118 may be configured to generate pose data based on the pose state.

Furthermore, the sensor unit 102 may include a positioning sensor 102d for confirming the position of the vehicle 100. The positioning sensor 102d is, for example, but not limited to, a Global Positioning System (GPS) sensor or a Global Navigation Satellite System (GNSS) sensor.

Furthermore, although not shown in FIG. 1, the sensor unit 102 may include a brake sensor and a wheel sensor. The brake sensor is configured to detect a braking degree of the brake, and the wheel sensor may detect, for example, a wheel speed, a wheel rotation angle, and a wheel rotation angular speed of the wheel. The present disclosure mainly describes the sensors of the sensor unit 102 referred to in the description of the exemplary embodiment of the present disclosure, and may further include sensors that detect various situations not listed therein.

The operation unit 104 may be configured as a module for a user to steer for driving. For example, the operation unit 104 may be a steering wheel for manual driving, an automatic or manual transmission actuator, an accelerator pedal, a brake pedal, a gear transmission, or the like. The operation unit 104 may further include an interface for using, releasing, and selecting a detailed function of the autonomous driving mode requested from the user, so that the user utilizes the autonomous driving function. The operation unit 104 may be configured with, for example, a hard type interface disposed at a predetermined position inside the vehicle 100, or a soft type interface that is touchable on the display 106, to receive various requests related to autonomous driving.

The display 106 may function as a user interface. The display 106 may be displayed by the processor 118 to output an operation state of the vehicle 100, a control state, path/traffic information, remaining energy information, content requested by the driver, and the like. Furthermore, the display 106 may be configured with a touch screen on which driver input is detectable to receive a driver's request instructing the processor 118.

The communication unit 110 may support mutual communication with the server 200, the ITS device 300, the surrounding vehicle 400 and the like. The communication unit 110 may include, for example, a module that processes cellular communication, WAVE, DSRC communication, and the like. In an exemplary embodiment of the present disclosure, a transmission/reception unit 116 may transmit data generated or stored while driving to the server 200 in a signal form, and receive data and a software module transmitted from the server 200 as a specific type of signal.

The communication unit 110 may support communication for transmitting or receiving signals related to data, control, commands, and requests between the components of FIG. 2. The component may be an instrument or module referred to as 102, 104, 106, 108, 110, 112, 114, 116 and 118 illustrated in FIG. 2. The communication unit 110 may transmit a signal transmitted between components, that is, a signal related to data, control, command, and request, to a communication bus by using, for example, Controller Area Network (CAN) communication, and transmit the signal to a specific component. Data, controls, commands, and requests transmitted via CAN communication may be referred to as CAN data.

The communication unit 110 may support communication with an electronic device carried by a passenger inside the vehicle 100. In an exemplary embodiment of the present disclosure, the vehicle 100 may transmit and receive data utilized in the method according to an exemplary embodiment of the present disclosure to or from the outside thereof through the communication unit 110.

Furthermore, the vehicle 100 may include the power source unit 112 and the actuator 114.

The power source unit 112 may be configured to generate and supply power and electric power to be used for a driving power system and a non-driving power system such as the actuator 114. The non-driving power system may be, for example, but not limited to, the sensor unit 102, the operation unit 104, the display 106, the load device 108, the communication unit 110, and the like, and may include various components that implement sensing, interface, communication, and convenience functions except for components directly involved in driving operations.

When the vehicle 100 is driven on an electrical energy basis, the power source unit 112 may include, for example, an electrical battery charged from the outside thereof, or may be configured with a combination of an electrical battery and a fuel cell for charging the battery. In the case of a combination of an electric battery and a fuel cell, the power source unit 112 may include a tank that stores a material used to generate power of the fuel cell, such as liquefied hydrogen. When the vehicle 100 is driven on a fossil energy basis, the power source unit 112 may be configured as an internal combustion engine. Furthermore, when the vehicle 100 is of a hybrid type, the power source unit 112 may be disposed by a combination of an internal combustion engine and an electric battery.

The actuator 114 includes at least one module that implements a driving operation, and may execute the driving operation based on a signal according to a user request from the operation unit 104 or a request of the processor 118. The signal according to the request may be associated with at least one of a longitudinal control such as acceleration or deceleration, a lateral control such as steering, a gear shifting, for example. Here, the gear shifting may be handled by the request of a manual driving user using a gear shifter or the processor 118 in autonomous driving.

The actuator 114 may include a wheel drive unit, a mechanical component and an electronic module for implementing a driving operation in the wheel drive unit, to perform a driving operation according to a command of the processor 118 by a user's manual operation or autonomous driving. When the vehicle 100 is operated on an electrical energy basis, it may include an assembly for transmitting the requested driving operation to the wheel drive unit. When the vehicle 100 is operated on a fossil energy basis, the actuator 114 may include a transmission, gear module that transmits the power of the internal combustion engine.

The wheel drive unit may include a plurality of wheels, a driving force generation module for generating a driving force and applying or transmitting the driving force to the wheels, a braking module for decelerating driving of the wheels, and a steering module for realizing lateral control of the wheels. When the vehicle 100 is driven on an electrical energy basis, the driving force generation module may be configured with a motor assembly that generates a driving force based on power output from an electrical battery. When the vehicle 100 is driven on a fossil energy basis, the driving force generation module may be an engine or a transmission assembly. The braking module of the electric-based vehicle 100 may further have a regenerative braking function.

Furthermore, the vehicle 100 may include a memory 116 and the processor 118.

The memory 116 may store applications and various data for control of the vehicle 100 to load the applications or read and write data at the request of the processor 118. In an exemplary embodiment of the present disclosure, the memory 116 may include an example according to an exemplary embodiment of the present disclosure, that is, an application that tracks an object detected from the sensor unit 102. In an exemplary embodiment of the present disclosure, for convenience of description, it may implement that the radar sensor 102b detects an object around the vehicle 100, and the application generates radar object data related to the object, and tracks the object using the data.

Radar object data may include tracks based on point cloud data obtained by the radar sensor 102b. The track may be disposed as an area having a boundary surrounding an object identified from the point cloud data. In an exemplary embodiment of the present disclosure, the track may be described interchangeably with a track area or a radar track, for purposes of distinction from other terms. The track is included in track information, and in an exemplary embodiment of the present disclosure, the track information may be described in combination with radar track information, for distinction from other terms. The radio detection and ranging (RADAR) track information may include, for example, a track area, a track identifier, a position of an object, a speed of the object, heading data of the object, a heading change rate of the object, the type (or class) of the object, reliability of the object estimation, and the number of times the track is maintained. In an exemplary embodiment of the present disclosure, the object may be described interchangeably with a tracked object. The heading data may include, for example, a heading angle. The number of times the track is maintained may mean, for example, the number of times the existing track estimated to be the same as the newly obtained track in the association and track information management in FIG. 3 is updated with the track information of the new track so that the existing track is maintained without being lost.

The application may perform specific processing on point cloud data to generate a new radar track, and include processing to predict a state of a tracked object based on radar track information of a previously generated preceding radar track. Furthermore, the application may include processing of generating ego behavior influence data of the vehicle 100 (or host vehicle) based on the predicted speed of the tracked object and the estimated speed of the preceding radar track. The estimated speed of the preceding radar track may be the speed of the tracked object included in the track information of the tracked object (that is, the state data of the tracked object) output as the object state estimation shown in FIG. 3.

In an exemplary embodiment of the present disclosure, the estimated speed may be generated based on track information of a track processed by association and management of the track shown in FIG. 3. The predicted speed is generated in the object state prediction shown in FIG. 3, and may be generated based on track information of a preceding radar track, such as speed, position, and heading data in the preceding track, rather than a new radar track. In an exemplary embodiment of the present disclosure, the estimated speed and the predicted speed may have different meanings in view of the above.

The application may include processing for associating tracks by identifying an identity between existing tracks and a new radar track including a nearest radar track using a result of the prediction processing and an association condition between the tracks. Furthermore, the application may include a process of managing the track so that the track identifier is newly given, or the track is maintained or deleted, according to a result of the association process.

The application may include processing to generate an absolute heading change rate of the tracked object based on the ego behavior influence data and track information of the track maintained in the management processing. The track information of the maintained track may include track information of a new track and track information of a preceding track. The track information of the new track is, for example, an estimated speed, and the track information of the preceding track may include, for example, absolute heading data of the tracked object.

Furthermore, the application may include processing of fusing the image object data detected from the image sensor 102a with the radar object data during the association processing. The fused object data, that is, the fused track, may be used for association processing, and the track information used for management of the track information may be disposed based on the fused track.

The processor 118 may perform overall control of the vehicle 100. The processor 118 may be configured to execute applications and instructions stored in the memory 116. The processor 118 may generate, in accordance with a driving control request in manual driving and autonomous driving, a signal related to control for a component of the vehicle 100. The component may be at least one of the various members described in FIG. 2. The processor 118 may include, for example, at least one of a Central Processing Unit (CPU), a Graphical Processing Unit (GPU), and a Neural Processing Unit (NPU). The processor 118 may, in an exemplary embodiment of the present disclosure, function as a controller. The controller includes the processing unit, a cache memory, a bus interface, and the like, and may be, for example, an Electric Control Unit (ECU).

The processor 118 may execute various processes related to radar object data for track tracking in accordance with the present disclosure.

Referring to FIG. 3, a processor 118 that processes position determination and track tracking of a radar track obtained from the radar sensor 102b will be described. FIG. 3 is a diagram schematically showing object recognition. For convenience of description, the present disclosure omits fusion of image tracks of image object data, and mainly describes association by a radar track and management of track information. The association and track information management based on the fusion track in which the image track and the radar track are fused may be similar to the following description unless technically contradictory.

The processor 118 of the vehicle 100 may select valid data from radio detection and ranging (RADAR) data, such as point cloud data, obtained from the RADAR sensor 102b, and process preprocessing for clustering the selected valid data.

Here, the RADAR data is exemplified by point cloud data, but may refer to a track and track information in an exemplary embodiment of the present disclosure. The preprocessing may include, for example, filtering to remove noise and outliers in the point cloud data, synchronizing with other sensor data, and the like. The synchronization may include, for example, synchronous processing between both sensors in terms of time and space of image data. Here, the image data may be image object data including a type (e.g., a class) and a state (e.g., a position, a speed, and the like) of an object by object recognition, but may also refer to image data in a raw state before object recognition in an exemplary embodiment of the present disclosure.

The clustering may include clustering, based on a distribution state of the point cloud data and statistical data related to the distribution, the point cloud data to generate a radar track and generating radar track information for each radar track. A radar track may be generated to represent an object that is estimated from point cloud data.

The processor 118 may include processing to predict a state of the tracked object based on the previously generated radar track information of the preceding radar track. Hereinafter, the radar track and the radar track information may be abbreviated as a track for convenience of description, unless they are confused with the track and the track information related to the image data. The state of the tracked object may include a position, velocity, heading data, acceleration, etc., predicted at a predetermined time after the preceding track. The predetermined time is, for example, a frame after the preceding track, or it may be a frame time at the time of obtaining the track generated in pre-processing/clustering. In an exemplary embodiment of the present disclosure, the predetermined time may be referred to as a first time point. The frame time of the radar sensor 102b at the time of obtaining the preceding radar track may be a second time point. The prediction of the object state utilizes a predetermined filter, for example, a Kalman filter, and the following prediction state may be estimated based on the dynamic model.

The processor 118 may execute a process of generating the ego behavior influence data of the host vehicle based on the predicted speed of the tracked object recognized at the first time point and the estimated speed of the tracked object at the second time point.

The processor 118 may be configured to determine the identity between the preceding and generating tracks by searching for tracks (specifically, tracks generated in the preprocessing) that match the state of the object predicted from the preceding tracks, and executing processing that associates the generating tracks with the preceding tracks. The association processing may be performed by, for example, a distance between tracks, a gate (or window) of a specific size for determining the same object, a probabilistic association, or the like.

The processor 118 may include processing of newly assigning a track identifier, or maintaining or deleting a track, according to a result of the association processing. When the newly detected object persists for a time period, a new identifier may be assigned to the track. When the track is maintained, track information of the associated track may be reflected in the existing track and updated. When the target object disappears from the region of interest of the sensor unit 102 and the particular track does not match the track information of the existing track for a time period, the existing track may be deleted.

The processor 118 may perform processing of generating, in the object state estimation of FIG. 3, absolute heading data of the tracked object at the first time point based on the ego behavior influence data and the estimated speed of the tracked object in the first time point. Here, the heading data may include a heading angle. Furthermore, the processor 118 may implement processing of generating, based on the absolute heading data and the heading data of the tracked object at the second time point, an absolute heading change rate of the tracked object.

The processor 118 may execute processing of generating, in the object state estimation of FIG. 3, track information that estimates the state of the tracked object based on the absolute heading rate of change and the data of the track associated with the tracked object. The processor 118 may be configured for controlling the vehicle 100 based on the track information. For example, the processor 118 may establish a driving path based on the track information and control the actuator 114 based on a control signal based on the driving path.

As an exemplary embodiment of the present disclosure, image data utilized in track position determination may also be utilized for association and track information management. In the association processing, the processor 118 may fuse the image track recognized in the image data and the new radar track into a common space, and associate the image and the radar track in the common space to output fusion track information. The fusion may be performed through matching of objects detected at each sensor 102a, 102b, association/projection of matched objects using geometric parameters of each sensor 102a, 102b, and calibration of both track information. The fusion track information may include at least substantially the same data as the radar track information. The processor 118 may manage track information using the fusion track information and control the vehicle 100, e.g., the actuator 114, based on the fusion track information.

In an exemplary embodiment of the present disclosure, the processor 118 is illustrated as being configured as a single processing module. In an exemplary embodiment of the present disclosure, the processor 118 may be distributed into a plurality of processing modules so that the processing described above is executed by a distributed processing model.

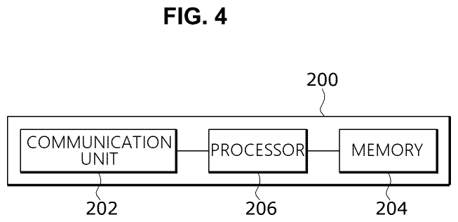

FIG. 4 is a diagram illustrating modules that configures a server according to an exemplary embodiment of the present disclosure.

The server 200 may transmit response data according to a request of the vehicle 100 to the vehicle 100, and also transmit an application embedded in the vehicle 100 and information for supporting vehicle driving to the vehicle 100. The server 200 may include a communication unit 202, a memory 204, and a processor 206.

The communication unit 202 may transmit and receive data to or from an external device, support mutual communication with the vehicle 100 in an exemplary embodiment of the present disclosure, and exchange data with the vehicle 100.

The memory 204 may store an application for operating the server 200 and various data to load the application or read and write data at the request of the processor 206. In an exemplary embodiment of the present disclosure, the memory 204 may manage data and software associated with a model for processing a sensor track embedded in the vehicle 100, such as a track based on the radar sensor 102b.

The processor 206 may perform overall control of the server 200. The server 200 may be configured to execute programs and instructions stored in the memory 204. The processor 206 may execute the application to process and respond to the user's request transmitted from the vehicle 100.

In an exemplary embodiment of the present disclosure, the processor 206 is illustrated as being configured as a single processing module. In an exemplary embodiment of the present disclosure, the processor 206 may be distributed into a plurality of processing modules, and the processing described above may be executed by a distributed processing model.

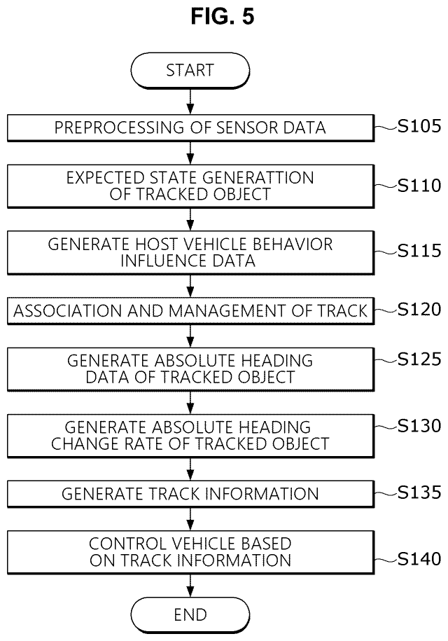

Hereinafter, a method for estimating the state of a tracking object according to another exemplary embodiment of the present disclosure will be described in detail with reference to FIG. 5. FIG. 5 is a flowchart of a method for estimating a state of a tracked object according to another exemplary embodiment of the present disclosure. The method of the present disclosure is performed by the processor 118, but for convenience of description, the processor 118 and the vehicle 100 may be described interchangeably.

Referring to S105 of FIG. 5, the processor 118 of the vehicle 100 may preprocess sensor data, e.g., point cloud data, of an object detected from the radar sensor 102b. The preprocessing may process preprocessing of selecting valid data from point cloud data and clustering the selected valid data. The preprocessing is described in detail in FIG. 3, and the description thereof will be omitted.

Referring to S110 of FIG. 5, the processor 118 may be configured to predict the state of the tracked object based on the previously generated radar track information of the preceding radar track.

The tracked object may be an object associated with a preceding radar track obtained at a time prior to the detection time of the radar sensor 102b performed at S105. In an exemplary embodiment of the present disclosure, the frame time of the radar sensor associated with step S105 corresponds to a first time point, and hereinafter, the first time point may be referred to as “t”. The frame time of the radar sensor 102b at the time of obtaining the preceding radar track corresponds to a second time point, and the second time point may be referred to as ‘t−1’.

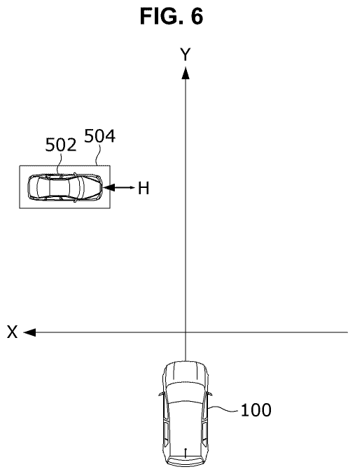

The preceding radar track may be a track that identifies, by association and management of the track of FIG. 3, a new further determined object or a retention of an existing object as a tracked object. The track information associated with the tracked object may include, for example, a track area, a track identifier, a location of the object, a speed of the object, an angle of heading of the object, the rate of change of heading of the object, a class of the object, reliability of the object estimation, the number of times the track is maintained, and the like. A track 504 of a tracked object 502 may be represented in a relative coordinate system of the vehicle center, as illustrated in FIG. 6. FIG. 6 is a diagram illustrating a tracked object and a track in a relative coordinate system of a vehicle center. The association and management of the tracks in FIG. 3 and the tracks of the tracked object recognized at the first time point via S120 in FIG. 5 may also be provided in the relative coordinate system of the vehicle center.

The state prediction of the tracked object utilizes a predetermined filter, for example, a Kalman Filter that employs radar track information of a preceding radar track as an input, and the following prediction state may be estimated based on the dynamic model. The predicted state of the tracked object may include a position, velocity, heading data, acceleration, etc., predicted at a first time point after the preceding track. With respect to the speed during the predicted state, the processor 118 may be configured to generate the predicted speed of the tracked object at the first time point based on data (e.g., radar track information) of the track associated with the tracked object recognized at the second time point.

Referring to S115 of FIG. 5, the processor 118 may be configured to generate ego behavior influence data based on the predicted speed of the tracked object at the first time point and the estimated speed of the tracked object recognized at the second time point.

The estimated speed of the tracked object at the second time point may be a speed of the tracked object included in the state data of the track corresponding to the second time point. The state data of the track at the second time point may be, for example, at least one data forming the radar track information.

The ego behavior influence data may be generated, for example, as data in units of speed. The ego behavior influence data may be generated based on a difference between the predicted speed at the first time point t and the estimated speed at the second time point t−1. The predicted speed of the first time point t may be determined based on the estimated speed of the second time point t−1, the ego behavior influence data, and the behavior influence data of the tracked object. Typically, when the starting of the object, e.g., turning, rapid acceleration, or rapid deceleration, is not large, the motion model of the object may use a constant velocity model, so that the acceleration of the tracked object may be substantially zero. Accordingly, the prediction speed at the first time point t may not take into account the behavior influence data of the tracked object, and the prediction speed at a first time point t may be determined by the estimated speed and the ego behavior influence data at the second time point t−1.

The predicted speed and the estimated speed may be described as two-dimensional vector data in the relative coordinate system of the vehicle center illustrated in FIG. 6. In the instant case, the ego behavior influence data may be generated as two-dimensional vector data by the following equation 1.

$$[ \begin{matrix}Δ {v}_{x}^{h} \\ Δ {v}_{y}^{h}\end{matrix} ] = X ( t \vert t - 1 ) - X ( t - 1 \vert t - 1 ) \qquad [ Equation 1 ]$$

wherein

$$[ \begin{matrix}Δ {v}_{x}^{h} \\ Δ {v}_{y}^{h}\end{matrix} ]$$

is the ego behavior influence data, X(t|t−1) is the predicted speed of the tracked object at the first time point, X(t−1|t−1) is the estimated speed of the tracked object at the second time point.

Referring to S120 of FIG. 5, the processor 118 may associate the tracked object based on the similarity between the tracked object recognized at the first time point t and the tracked object at the second time point t−1, and manage the tracked object according to a result of the association processing.

The processor 118 may be configured to determine the identity between the preceding and generating tracks by searching the generating radar track (e.g., the track generated with the object detected in S105) that matches the predicted state of the tracked object, and interassociating the generating radar track with the preceding radar track. The association processing may be performed by, for example, a distance between tracks, a gate (or window) of a particular size for determining the same object, a probabilistic association, or the like.

The processor 118 may newly assign a track identifier, or maintain or delete a track, according to a result of the association processing. The processing of such tracks may be management processing. When the track is maintained, track information of the associated track may be reflected in the existing track and updated. When the newly detected object persists for a time period, a new identifier may be assigned to the track. The object associated with the retaining or new track may be a tracked object. The track managed by S120 may be disposed in the relative coordinate system of the vehicle center illustrated in FIG. 6. The processor 118 generates radar track information of the managed track, and the generated radar track information may include data of the track of the tracked object recognized at the first time point t through S120. In an exemplary embodiment of the present disclosure, from the viewpoint that the data of the track is generated by the association and management of S120, the data of the track may be referred to as data of an associated tracked object, from the viewpoint that the data of the trace is generated with association and management of S120. The processor 118 may generate, based on at least some of data included in the radar track information, an estimated speed of the tracked object at the first time point t.

Referring to S125 of FIG. 5, the processor 118 may be configured to generate absolute heading data of the tracked object at the first time point t based on the ego behavior influence data and the estimated speed of the tracked object in the first time point.

The absolute heading data may be generated, for example, by an inverse triangulation function for the difference between the estimated velocity of the tracked object at the first time point t and the ego behavior influence data. The absolute heading data may include, for example, an absolute heading angle, and the absolute heading angle may include a heading angle of the tracked object in an absolute coordinate system that employs a predetermined point as a reference. The absolute heading angle may be a heading angle that is described in the absolute coordinate system with an effect of the host vehicle behavior excluded.

As illustrated in S115, when the estimated velocity and the ego behavior influence data are described as two-dimensional vector data, the absolute heading data (Ψ₁) of the tracking object at the first time point t may be generated by the following equation 2.

$${Ψ}_{1} = atan ( \frac{{v}_{y} ( t \vert t ) - Δ {v}_{y}^{h}}{{v}_{x} ( t \vert t ) - Δ {v}_{x}^{h}} ) \qquad [ Equation 2 ]$$

wherein vₓ(t|t)v_{y}(t|t) is the estimated speed of the tracked object at the first time point,

$$Δ {v}_{x}^{h} Δ {v}_{y}^{h}$$

is the ego behavior influence data.

Through the above-described processing, the absolute heading data may be generated to convert the heading angle of the tracked object from the coordinate system of the host vehicle center to the absolute coordinate system.

Referring to S130 of FIG. 5, the processor 118 may generate, based on the absolute heading data and the heading data of the tracked object at the second time point t−1, an absolute heading change rate of the tracked object.

The heading data of the tracked object at the second time point t−1 may be obtained from data of a track associated with the tracked object recognized at the second time point. The heading data may include, for example, a heading angle, and the data of the track may be data included in the radar track information of the preceding radar track. Here, the heading angle may be a heading angle of the tracked object in an absolute coordinate system employed based on a predetermined point. The heading data of the second time point t−1 may be described in the absolute coordinate system described in S125.

The heading data of the tracked object at the second time point t−1 (Ψ₂) may be generated by the following equation 3:

$${Ψ}_{2} = atan ( \frac{( {v}_{y} ( t - 1 \vert t - 1 )}{( {v}_{x} ( t - 1 \vert t - 1 )} ) \qquad [ Equation 3 ]$$

wherein vₓ(t−1|t−1)v_{y}(t−1|t−1) is the estimated speed of the tracked object at the second time point.

The absolute heading rate of change of the tracked object (\dot{ψ}(t)) may be generated by the following equation 4:

$$\dot{ψ} ( t ) = \frac{{Ψ}_{1} - {Ψ}_{2}}{T} \qquad [ Formula 4 ]$$

Here, T is an acquisition period of the radar sensor, and may be a difference between the first time point t and the second time point t−1.

Referring to S135 of FIG. 5, the processor 118 of the vehicle 100 may generate, based on the absolute heading change rate and the data of the track associated with the tracked object, track information that estimates the state of the tracked object. For example, the data of the track may be data included in the radar track information, and the track information may be the radar track information as described above. For example, the radar track information may include a track area, a track identifier, a position of an object, a speed of the object, heading data of the object, a heading change rate of the object, class of the object, reliability of the object estimation, the number of times the track is maintained, and the like, as described above.

Referring to S140 of FIG. 5, the processor 118 may be configured for controlling an operation of the vehicle 100 based on the track information. For example, the operation control of the vehicle 100 may include autonomous driving control. As an exemplary embodiment of the present disclosure, the operation control of the vehicle 100 may include control of an actuator 114 for longitudinal or lateral control, providing a path, vehicle lamp control, or control of other vehicle convenience devices.

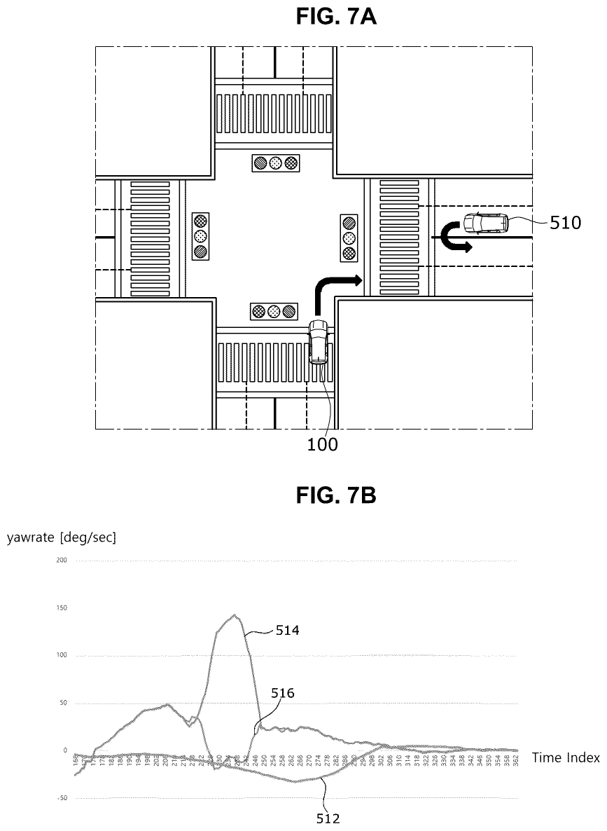

FIG. 7A is a diagram illustrating an example of a behavior change of the host vehicle. In FIG. 7A, the vehicle 100 corresponding to the host vehicle makes a right turn, and a tracked object 510 makes a U-turn while being disposed laterally with respect to the vehicle 100. FIG. 7B is a graph showing the heading angle of the tracked object in the absolute coordinate system and the relative coordinate system of the vehicle center in the situation of FIG. 7A. FIG. 7B is a diagram illustrating a yaw rate of a tracked object in each of an absolute coordinate system and a relative coordinate system of a vehicle center in an example of a behavior change of the host vehicle.

Referring to FIG. 7B, the diagram of 512 is the yaw rate of the host vehicle 100, and the diagrams of 514 and 516 are the yaw rates of the tracked object 510 in the absolute coordinate system and the yaw rate of the tracked object 510 in the relative coordinate system of the vehicle center generated, respectively, according to an exemplary embodiment of the present disclosure. The diagram of 514 according to an exemplary embodiment of the present disclosure shows that in a situation in which the tracked object 510 makes a U-turn while the host vehicle 100 turns right, the yaw rate of the tracked object 510 changes in a constant direction (+). On the other hand, the diagram of 516 according to the relative coordinate system shows that, when the host vehicle 100 turns right and the tracked object 510 makes a U-turn, the yaw rate sign of the tracked object 510 changes from (+) to (−) due to the influence of the behavior of the host vehicle 100. The diagram of 516 shows an incorrect yaw rate of the tracked object 510.

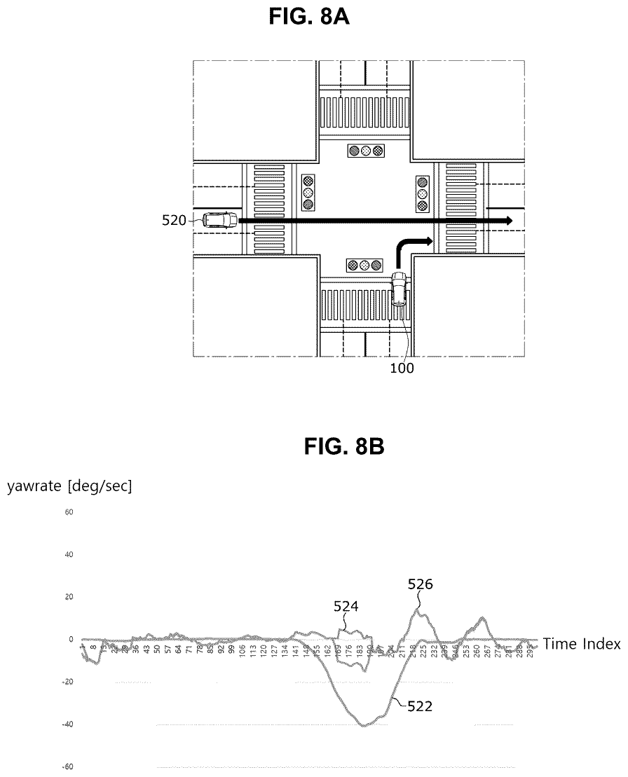

FIG. 8A is a diagram illustrating another example of a behavior change of the host vehicle. In FIG. 8A, the vehicle 100 corresponding to the host vehicle makes a right turn, and a tracked object 520 goes straight in the lateral direction with respect to the vehicle 100. FIG. 8B is a diagram showing the heading angle of the tracked object in the absolute coordinate system and the relative coordinate system of the vehicle center in the situation of FIG. 8A. FIG. 8B is a diagram illustrating a yaw rate of a tracked object in each of an absolute coordinate system and a relative coordinate system of a vehicle center in another example of a behavior change of the host vehicle.

Referring to FIG. 8B, the diagram 522 is a yaw rate of the host vehicle 100, and the diagram 524 and the diagram 526 are respectively a yaw rate for the tracked object 520 in the absolute coordinate system and a yaw rate in the tracked object 520 at the relative coordinate system of the vehicle center generated according to an exemplary embodiment of the present disclosure. The diagram of 524 according to an exemplary embodiment of the present disclosure shows that the yaw rate of the tracked object 520 is constant in a situation where the tracked object 520 goes straight regardless of the turning of the host vehicle 100. On the other hand, the diagram of 526 according to the relative coordinate system shows that the yaw rate of the object 520 moving straight is not constant due to the influence of the behavior of the host vehicle 100. That is, the diagram of 526 indicates an incorrect yaw rate of the tracked object 520.

According to an exemplary embodiment of the present disclosure, by removing the behavioral influence of the host vehicle in the generation of the heading change rate of the object, the net heading change rate unique to the object may be accurately generated. The net heading change rate unique to the object may be utilized in the setting of an adaptive gate for the determination of the same object used in the track association. Since the behavior of the host vehicle is not affected in an environment such as a rapid turning situation of the host vehicle, a large rotation situation of the track, or the like, an accurate change of the track may be identified.

According to an exemplary embodiment of the present disclosure, it is possible to provide a method and vehicle of estimating a state of a tracked object that improves the accuracy of object tracking.

The effects obtainable in an exemplary embodiment of the present disclosure are not limited to the effects mentioned above, and other effects not mentioned will be clearly understood by a person skilled in the art from the following description.

While the exemplary methods of the present disclosure described above are represented as a series of operations for clarity of description, it is not intended to limit the order in which the steps are performed, and the steps may be performed simultaneously or in different order as necessary. To implement the method according to an exemplary embodiment of the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

Furthermore, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

What is claimed is:

1. A method for estimating a state of a tracked object, the method comprising:
generating ego behavior influence data of a host vehicle based on a predicted speed of the tracked object at a first time point, the predicted speed of the tracked object being provided from sensor data, and an estimated speed of the tracked object perceived at a second time point preceding the first time point;
generating absolute heading data of the tracked object at the first time point based on the ego behavior influence data and an estimated speed of the tracked object perceived at the first time point;
generating an absolute heading change rate of the tracked object based on the absolute heading data and heading data of the tracked object at the second time point; and
controlling the host vehicle based on the absolute heading change rate of the tracked object.

2. The method of claim 1,
wherein the predicted speed of the tracked object at the first time point is predicted based on data of a track associated with the tracked object perceived at the second time point, and the estimated speed of the tracked object at the second time point is generated based on a speed of the tracked object included in state data of the track corresponding to the second time point.

3. The method of claim 1,
wherein the estimated speed of the tracked object at the first time point is generated based on data of a track associated with the tracked object perceived at the first time point.

4. The method of claim 1,
wherein the absolute heading data comprises a heading angle of the tracked object in an absolute coordinate system employed based on a predetermined point, and the absolute heading data is generated to convert the heading angle of the tracked object from a coordinate system of the host vehicle center to the absolute coordinate system.

5. The method of claim 1,
wherein the ego behavior influence data and the estimated speed of the tracked object at the first time point are described as two-dimensional vector data, and the absolute heading data is generated by an inverse trigonometric function for a difference between the estimated speed of the tracked object at the first time point and the ego behavior influence data.

6. The method of claim 1,
wherein the heading data of the tracked object at the second time point is generated based on data of a track associated with the tracked object perceived at the second time point, and comprises a heading angle of the tracked object in an absolute coordinate system employed based on a predetermined point.

7. The method of claim 1, wherein the controlling of the host vehicle comprising:
generating, based on the absolute heading change rate and data of a track associated with the tracked object, track information that estimates a state of the tracked object; and
controlling, based on the track information, an operation of the host vehicle.

8. The method of claim 7, wherein the controlling of the operation of the host vehicle comprising controlling driving of the host vehicle based on the track information.

9. The method of claim 1, further comprising:
before the generation of the absolute heading data,
associating the tracked object based on a similarity between the tracked object perceived at the first time point and the tracked object at the second time point; and
generating the estimated speed of the tracked object at the first time point based on data of the associated tracked object.

10. A vehicle, comprising:
a sensor unit detecting a surrounding environment of the vehicle;
a memory storing at least one instruction; and
at least one processor communicatively to the sensor unit and the memory and executing the at least one instruction stored in the memory,
wherein the at least one processor:
generates ego behavior influence data based on a predicted speed of a tracked object at a first time point, the predicted speed of the tracked object being provided from sensor data obtained by the sensor unit, and an estimated speed of the tracked object perceived at a second time point preceding the first time point;
generates absolute heading data of the tracked object at the first time point based on the ego behavior influence data and an estimated speed of the tracked object at the first time point;
generates an absolute heading change rate of the tracked object based on the absolute heading data and heading data of the tracked object at the second time point; and
controls the vehicle based on the absolute heading change rate of the tracked object.

11. The vehicle of claim 10,
wherein the predicted speed of the tracked object at the first time point is predicted based on data of a track associated with the tracked object perceived at the second time point, and the estimated speed of the tracked object at the second time point is generated based on a speed of the tracked object included in state data of the track corresponding to the second time point.

12. The vehicle of claim 10,
wherein the estimated speed of the tracked object at the first time point is generated based on data of a track associated with the tracked object perceived at the first time point.

13. The vehicle of claim 10,
wherein the absolute heading data comprises a heading angle of the tracked object in an absolute coordinate system employed based on a predetermined point, and the absolute heading data is generated to convert the heading angle of the tracked object from a coordinate system of the host vehicle center to the absolute coordinate system.

14. The vehicle of claim 10,
wherein the ego behavior influence data and the estimated speed of the tracked object at the first time point are described as two-dimensional vector data, and the absolute heading data is generated by an inverse trigonometric function for a difference between the estimated speed of the tracked object at the first time point and the ego behavior influence data.

15. The vehicle of claim 10,
wherein the heading data of the tracked object at the second time point is generated based on data of a track associated with the tracked object perceived at the second time point, and comprises a heading angle of the tracked object in an absolute coordinate system employed based on a predetermined point.

16. The vehicle of claim 10,
wherein, for the controlling of the vehicle, the at least one processor:
generates, based on the absolute heading change rate and data of a track associated with the tracked object, track information that estimates a state of the tracked object; and
controls, based on the track information, an operation of the vehicle.

17. The vehicle of claim 16,
wherein, for the controlling of the operation of the vehicle, the at least one processor controls driving of the vehicle based on the track information.

18. The vehicle of claim 10,
wherein before the generation of the absolute heading data, the processor:
associates the tracked object based on a similarity between the tracked object perceived at the first time point and the tracked object at the second time point; and
generates the estimated speed of the tracked object at the first time point based on data of the associated tracked object.
